(19) United States
(12) Patent Application Publication
(10) Pub. No.: US 2026/0135708 A1
(43) Pub. Date: May 14, 2026

(54) CALLER VERIFICATION

(71) Applicant: Wells Fargo Bank, N.A., San Francisco, CA (US)

(72) Inventors: Basil F. Nimry, West Des Moines, IA (US); Nicholas R. Gillis, Martinsburg, WV (US)

(21) Appl. No.: 18/945,068

(22) Filed: Nov. 12, 2024

(51) Int. Cl. H04L 9/32; G06F 21/57

(52) U.S. Cl. CPC H04L 9/3213; G06F 21/57

(57) ABSTRACT

This disclosure describes techniques enabling a computing device to verify the source of an incoming communication request, such as a phone call, by leveraging at least some aspects of a trusted application that may be executing on the computing device. In one example, this disclosure describes a method that includes requesting communication with a user device, wherein requesting communication includes sending a validation token to the user device over a network; after sending the validation token to the user device, receiving, from the user device over the network, a verification request; determining whether the verification request includes information derived from the validation token; outputting, to the user device over the network, an indication of whether the verification request includes information derived from the validation token; and enabling the user device to determine, based on the indication, whether to establish communication between the user device and the computing system.

### TECHNICAL FIELD

This disclosure relates to computing systems, and more specifically, to techniques for verifying the identity of a person, organization, or computing system that is requesting to engage in communications.

### BACKGROUND

Caller ID is a telecommunications feature available in analog and digital telephone systems that transmits a caller's telephone number to the called party's telephone equipment when the call is being set up. Caller ID is designed to display the phone number of an incoming call on a recipient's device, and often the caller's name if that information is available. This enables the call recipient to identify who is calling before answering the call, thereby providing a layer of convenience and security. By knowing the origin of the call, call recipients can decide whether to pick up, ignore, or block the number, which is particularly useful for avoiding unwanted or spam calls.

It is relatively easy to modify the information transmitted as the caller ID. As a result, the information presented as the purported caller through caller ID is often inaccurate, and in general, caller ID is not a reliable way to determine the true origin of a call. As might be expected, modifying the caller ID can be and has been used to disguise the actual caller for various purposes, including fraud.

### SUMMARY

This disclosure describes techniques that verify the source of an incoming communication request, such as a phone call, through use of a trusted application executing on a user device. In some examples, the application executing on the user device may be installed through a process involving a trusted application publisher.

As described herein, when a user device receives a call, the application executing on the computing device may receive, along with the initiation of the call, information that can be used by the user device to verify the source of the call. Similarly, when the user device places a call, the application may send information that can be used by a recipient device to verify the source of the call.

In some examples, this disclosure describes operations performed by a computing system in accordance with one or more aspects of this disclosure. In one specific example, this disclosure describes a method comprising requesting, by a computing system, communication with a user device, wherein requesting communication includes sending a validation token to the user device over a network; after sending the validation token to the user device, receiving, by the computing system and from the user device over the network, a verification request; determining, by the computing system, whether the verification request includes information derived from the validation token; outputting, by the computing system and to the user device over the network, an indication of whether the verification request includes information derived from the validation token; and enabling, by the computing system, the user device to determine, based on the indication, whether to establish communication between the user device and the computing system.

In another example, this disclosure describes a system comprising a storage system and processing circuitry having access to the storage system, wherein the processing circuitry is configured to carry out operations described herein. In one specific example, processing circuitry included in such a computing device is configured to detect an indication of input requesting communication with a computing system; output, over a network and to a token services system accessible to the computing system, a request for a token; receive, in response to the request for the token and from the token services system over the network, a validation token; send, over the network and to the computing system, a request to communicate with the computing system, wherein the request includes information derived from the validation token; enable the computing system to determine, by interacting with the token services system, that the request includes information derived from the validation token; and after enabling the computing system to determine that request includes information derived from the validation token, communicate with the computing system.

In yet another example, this disclosure describes a computer-readable storage medium comprising instructions that, when executed, configure processing circuitry of a computing system to carry out operations described herein.

This Summary is intended to provide a brief overview of some of the subject matter described in this document. Accordingly, the above-described features are merely examples and should not be construed to narrow the scope or spirit of the subject matter described herein. Other features, objects, and advantages of the disclosure will be apparent from the description and drawings, and from the claims.

### BRIEF DESCRIPTION OF THE DRAWINGS

FIG. 1A is a conceptual diagram illustrating a system that verifies the source of a request to initiate communications with a user device, in accordance with one or more aspects of the present disclosure.

FIG. 1B is a conceptual diagram illustrating a system that verifies the source of a request to initiate communications from a user device, in accordance with one or more aspects of the present disclosure.

FIG. 2 is a block diagram illustrating a system that verifies the source of a phone call or other request to initiate communications, in accordance with one or more aspects of the present disclosure.

FIG. 3 is a flow diagram illustrating operations performed by an example computing system in accordance with one or more aspects of the present disclosure.

FIG. 4 is a flow diagram illustrating operations performed by an example user device in accordance with one or more aspects of the present disclosure.

Although each of the above-described Figures are referenced herein in connection with the description of one or more specific examples, such examples are merely illustrative, and each illustration can be used to provide support for other examples not specifically described herein. Accordingly, the one or more examples described herein with reference to any of the above-described Figures should not be construed to narrow the scope or spirit of the subject matter illustrated or otherwise disclosed herein.

### DETAILED DESCRIPTION

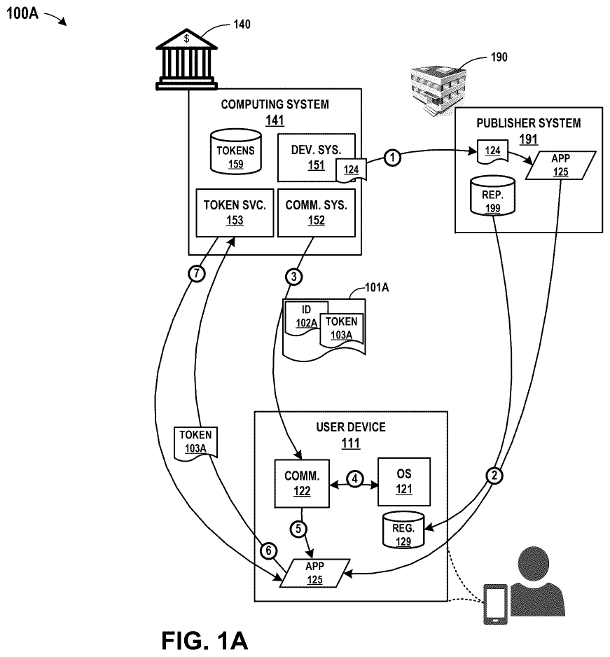

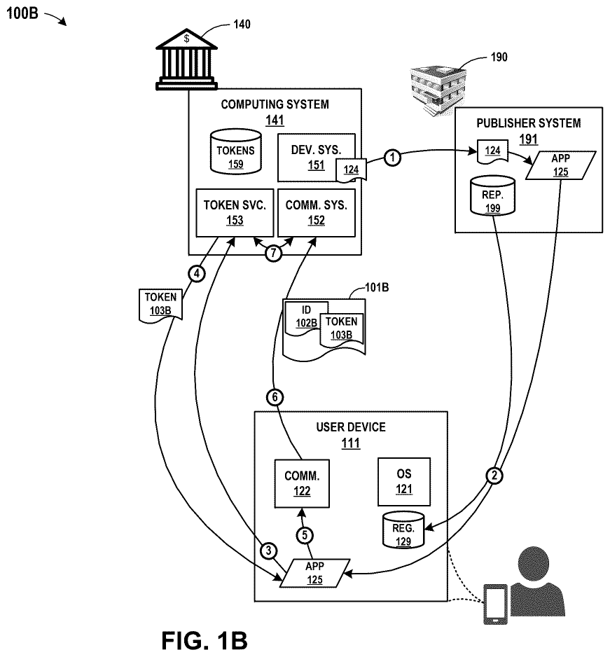

FIG. 1A is a conceptual diagram illustrating a system that verifies the source of a request to initiate communications (e.g., a phone call) with a user device, in accordance with one or more aspects of the present disclosure. System 100A of FIG. 1A includes organization 140, publisher 190, and user device 111. FIG. 1A illustrates operations occurring when organization 140 uses computing system 141 to initiate a call to a user operating user device 111.

User device 111 may be any appropriate computing device that may be operated by a user. Although examples herein may describe user device 111 as a mobile phone or smartphone making phone calls, user device 111 is not limited to such a device, and user device 111 may be any other type of computing device capable of engaging in communications and/or performing functions consistent with the techniques described herein. Accordingly, user device 111 may be implemented through any suitable computing system including any mobile, non-mobile, wearable, and/or non-wearable computing device, which may be a mobile phone or tablet, or a laptop or desktop computing device. In general, user device 111 may take any appropriate form, which may include a computerized watch, a computerized glove or gloves, a personal digital assistant, a virtual assistant, a gaming system, a media player, an e-book reader, a television or television platform, a bicycle, automobile, or navigation, information and/or entertainment system, or any other type of wearable, non-wearable, mobile, or non-mobile computing device that may perform operations in accordance with one or more aspects of the present disclosure.

One or more examples described herein may be described in the context of user device 111 making or receiving a phone call, which may be conventional phone call over a voice or cellular phone network. However, the techniques described herein may apply to other types of communications. For example, techniques described herein may apply to user device 111 initiating or receiving a voice or audio communication over a data network, a video communication over a data network, or any other type of communication over communications infrastructure now known or hereafter developed.

Organization 140 may be any organization or commercial entity. For example, organization 140 may be a bank, retailer, or any other consumer-facing business that might seek to communicate with users or customers through a computing device, such as user device 111. In some examples, such users or customers may use a computing device or smartphone (i.e., user device 111) on which various applications are installed, where such applications facilitate the user's interactions with any of a number of types of businesses or organizations 140 (e.g., banks, retailers, restaurants, shopping websites, travel or mobility services, etc.).

Publisher 190 may be an organization or commercial entity that publishes and/or distributes applications developed by third parties (e.g., organization 140), where such applications are installed and executed on user devices. In some examples, publisher 190 may administer and/or operate an application marketplace, which may be a website or platform where users can browse, download, and purchase apps for their devices. The application marketplace may be similar to marketplaces currently popular for various user devices, such as Apple's App Store for the iOS operating system, Google Play, Blackberry App World, and Samsung Apps. As described herein, and as is common for such application marketplaces, publisher 190 may verify the source of applications offered at the marketplace, ensuring that an application that is named and/or branded as being from “Company ABC” is actually authorized and developed by Company ABC. Publisher 190 may also evaluate applications published through its marketplace to ensure that each application offered through the marketplace sufficiently meets certain standards for privacy, security, and content. Accordingly, publisher 190 may serve as a trusted source for applications, and may be viewed as a safe place to discover and acquire applications for use on user devices.

At least some of the techniques described herein may be performed by computing system 141, which may be a system of one or more computing devices that perform functions on behalf of organization 140. Accordingly, organization 140 may own, operate, or otherwise control computing system 141 to perform functions as described herein.

Similarly, publisher 190 may own, operate, or otherwise control one or more publisher systems 191 to implement an application marketplace or to otherwise serve as a trusted third party that verifies the source, origin, characteristics, and/or operation of various applications that can be installed and executed on user device 111. Publisher 190 may own, operate, or otherwise control publisher system 191 to perform functions as described herein.

Computing system 141 and publisher system 191 may each be implemented as any suitable computing system or collection of computing systems, including one or more server or web server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a data center, cloud computing system, server farm, and/or server cluster.

In FIG. 1A, and in accordance with one or more aspects of the present disclosure, publisher 190 may publish an application developed by organization 140. For instance, in an example that can be described in the context of FIG. 1A, development system 151 detects input that corresponds to development activity performed by one or more developers on behalf of organization 140. Based on the input, development system 151 generates code 124. Development system 151 outputs code 124 over a network to publisher system 191 operated by publisher 190 (see arrow labeled “1”). Publisher system 191 verifies that the entity from which code 124 was received is organization 140. Publisher system 191 may also perform verifications on code 124 to ensure that code 124 complies with any guidelines and/or standards set by publisher 190 for applications and/or code 124 distributed by publisher 190. Publisher system 191 stores code 124 and/or information about code 124 in repository 199. Publisher system 191 makes code 124 available for download as application 125 and for use at one or more of user devices 111.

User device 111 may install application 125. For instance, continuing with the example being described in the context of FIG. 1A, publisher system 191 detects input that it determines corresponds to a request to download application 125. Publisher system 191 further determines that the request originated from user device 111. In response, publisher system 191 retrieves information from repository 199 about application 125. Publisher system 191 outputs a series of signals over a network to user device 111 (arrows labeled “2”). User device 111 receives the signals and determines that the signals include information sufficient to install application 125 at user device 111. User device 111 installs application 125 and prepares it for execution at user device 111. In connection with the installation, user device 111 uses information received from publisher system 191 to update device registry 129 with supporting information that application 125 may use to execute on the platform provided by operating system 121 on user device 111. Once installed, operating system 121 may cause application 225 to start executing. When application 125 is used at user device 111, the application 125 or the user device 111 generally is in an authenticated state, thereby ensuring that the user operating and/or providing input to the user device 111 is the authorized user.

Computing system 141 may initiate a call to user device 111. For instance, again with reference to FIG. 1A, computing system 141 detects input that communication system 152 of computing system 141 determines corresponds to a request to initiate a call to user device 111. Communication system 152 of computing system 141 determines the phone number or network address (or other routing or identifying information) for user device 111. Communication system 152 creates and sends information packet 101A over a network to user device 111 (see arrow “3”). In some examples, information packet 101A includes an identifier associated with organization 140 and a security token. For a phone call being initiated by computing system 141 to user device 111, the identifier may be a phone number serving as the caller ID number for the call (e.g., where the caller ID identifies organization 140). The security token may be any appropriate data that can serve as verification data in the manner described herein. In the example illustrated in FIG. 1A, both the identifier and the token are included within information packet 101A as identifier 102A and token 103A, respectively.

Application 125 of user device 111 may receive an indication of the call. For instance, still referring to FIG. 1A, communication module 122 of user device 111 receives a signal that it determines includes information packet 101A. Communication module 122 determines that the signal corresponds to an incoming call. Communication module 122 parses the data included within information packet 101A included with the signal, and determines that identifier 102A is included within information packet 101A. Communication module 122 interacts with operating system 121 to invoke an operating system service that identifies which of the applications available on user device 111 is associated with identifier 102A. Operating system 121 may interact with device registry 129 to identify the appropriate application. Operating system 121 outputs to communication module 122 information identifying application 125 as the application associated with identifier 102A (see arrows labeled “4”). Once application 125 is identified as the relevant application, communication module 122 outputs information to application 125 about information packet 101A (see arrow “5”).

Application 125 may verify the caller. For instance, again referring to FIG. 1A, application 125 extracts token 103A from information packet 101A. In some cases, application 125 may operate in a light state (e.g., consuming relatively few resources) when extracting, evaluating, and/or processing token 103A. Application 125 outputs a signal, over a network to computing system 141, that includes token 103A or information derived from token 103A (see arrow labeled “6”). Token services system 153 of computing system 141 receives the signal from user device 111 and determines that the signal includes or otherwise identifies token 103A. Token services system 153 validates token 103A by determining whether token 103A matches or otherwise was derived from the token that was previously communicated from computing system 141 to user device 111 within information packet 101A (see previously described arrow “3”). To make such a determination, token services system 153 may access information within token storage 159 and/or evaluate the received information to determine whether it establishes that user device 111 has access to token 103A. Once the determination is made, token services system 153 of computing system 141 outputs a signal over a network to user device 111 (arrow “7”), indicating whether the token was validated. Application 125 of user device 111 receives the signal and determines whether computing system 141 validated token 103A.

If computing system 141 validated token 103A, application 125 enables completion of the call initiated by computing system 141 to user device 111. To do so, application 125 may interact with communication module 122, causing communication module 122 to establish communication between user device 111 and computing system 141. In some examples, application 125 may also interact with operating system 121 to invoke operating system services that provide for user interface notification(s) to be presented on a display screen at user device 111, indicating that the incoming call has been validated as being from organization 140.

If computing system 141 did not validate token 103A, application 125 may refuse the call by interacting with communication module 122 to terminate the call. In some examples, application 125 may invoke operating system services that cause a user interface to be presented at user device 111 indicating that a call was received from a caller that could not be verified. In other examples where computing system 141 did not validate token 103A, application 125 might simply terminate the call without presenting a user interface notification at user device 111. In some examples, application 125 may route or forward the call elsewhere (e.g., to a security team, to law enforcement, or to an artificially intelligent agent) for evaluation and/or information gathering.

FIG. 1B is a conceptual diagram illustrating a system that verifies the source of a request to initiate communications (e.g. a phone call) from a user device, in accordance with one or more aspects of the present disclosure. Similar to FIG. 1A, system 100B of FIG. 1B includes organization 140, publisher 190, and user device 111. FIG. 1B illustrates operations occurring when a user operating user device 111 initiates a call to computing system 141 operated by organization 140.

In the example illustrated in FIG. 1B, it is assumed that computing system 141 has previously interacted with publisher system 191 to publish application 125, as described in connection with FIG. 1A, enabling 125 to be available for use by user devices 111 (see arrow “1”). Further, it is assumed that user device 111 has already downloaded and installed application 125, also as described in connection with FIG. 1A (see arrow “2”).

FIG. 1B differs from FIG. 1A in that in FIG. 1B, user device 111 is initiating a call to computing system 141 (rather than, as in FIG. 1A, computing system 141 initiating a call to user device 111). For instance, in an example that can be described with reference to FIG. 1B, user device 111 detects input that operating system 121 determines is intended for application 125. Application 125 receives information about the input from operating system 121 and determines that the input corresponds to a request to initiate a call from user device 111 to a device associated with or controlled by organization 140.

Before initiating the call, application 125 outputs a signal over a network to computing system 141 (arrow “3”). Token services system 153 of computing system 141 receives the signal and determines that the signal corresponds to a request for a token to be used for caller verification purposes. Token services system 153 generates token 103B (or retrieves token 103B from token storage 159). Token services system 153 causes computing system 141 to output a signal (including token 103B) over the network back to user device 111 (arrow “4”). Application 125 of user device 111 receives the signal and determines that the signal includes token 103B. Application 125 interacts with communication module 122 to initiate the requested call (arrow “5”). When application 125 interacts with communication module 122, application 125 instructs communication module 122 to include token 103B when initiating the call to computing system 141. Communication module 122 of user device 111 initiates the phone call by communicating a signal over a network to computing system 141 (see arrow “6”). When initiating the call, communication module 122 may include information packet 101B, which may include identifier 102B (e.g., a caller ID associated with user device 111) and token 103B.

Computing system 141 may receive an indication of the call from user device 111 and verify the caller. For instance, again with reference to FIG. 1B, communication system 152 of computing system 141 receives a signal that includes information packet 101B. Communication system 152 outputs information about information packet 101B to token services system 153 (see arrow “7”). Token services system 153 extracts token 103B from information packet 101B. Token services system 153 determines whether the extracted token 103B matches or otherwise corresponds to the token previously sent by computing system 141 to user device 111 (see previously described arrow “4”). If token 103B that is included within information packet 101B can be verified, computing system 141 concludes that the call being received is from user device 111. In that case, communication system 152 connects the call, enabling computing system 141 and user device 111 to communicate.

If, however, token 103B included within information packet 101B does not correspond to the token computing system 141 previously sent to user device 111, computing system 141 concludes that the call cannot be verified as originating from user device 111. In this situation, communication system 152 may refuse the call, and decline to enable computing system 141 and user device 111 to communicate.

Techniques described herein may provide certain technical advantages. For instance, by leveraging the trust relationship that often exists between publisher 190 and users of user devices 111, it may be possible to more effectively verify the source of various communications that occur between a user device and another computing device (such as computing system 141 or another user device). Also, to the extent that organization 140 and users of user devices 111 can rely on publisher 190 to verify the identity of developers creating each application, organizations 140 can assume that publisher 190 will not publish applications that falsely purport to be from organization 140. In other words, a counterfeit application 125 is unlikely to be used successfully to interact with computing system 141 to frustrate the processes described and illustrated in FIG. 1A and FIG. 1B.

Also, since the security of the processes described herein tends to depend primarily on a trusted application 125 executing on user device 111, changes to calling attributes or configurations of user device 111 (e.g., changes to sim cards, phone numbers, and the like) are unlikely to compromise the ability to accurately verify the identity of a caller. Further, when a user starts using a new user device 111 (e.g., a new smartphone), the techniques illustrated in FIG. 1A and FIG. 1B can be performed effectively by the new user device 111 simply by reinstalling application 125 on the new user device 111.

By identifying and/or verifying callers, as described herein, it may be possible to eliminate or reduce fraud, potential fraud, spam, and/or other unproductive behaviors. The described techniques may also enable calls to be accurately routed and/or prioritized, making communications more efficient, and ultimately reducing unproductive computing cycles. Further, if customers can reliably identify calls from businesses (and if businesses can reliably identify calls from customers), businesses can more effectively build customer trust.

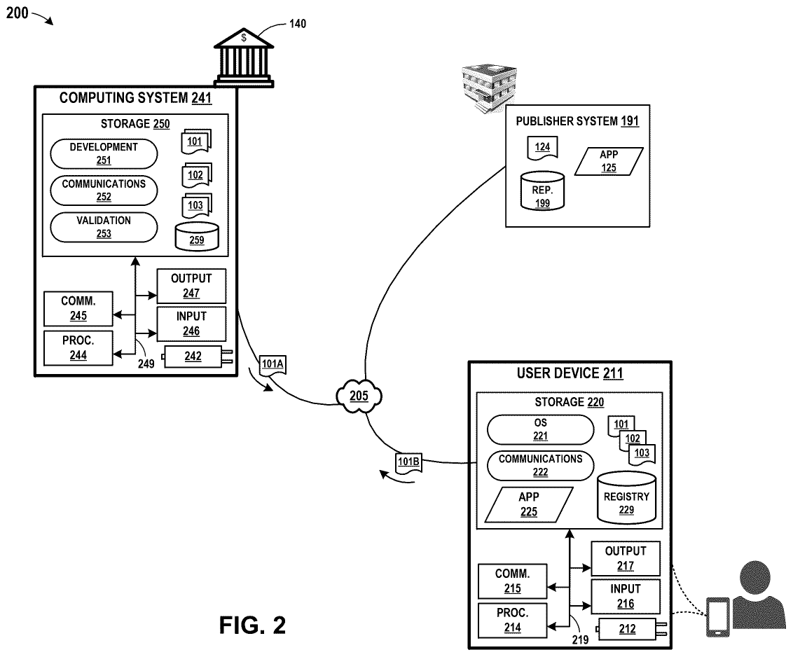

FIG. 2 is a block diagram illustrating a system that verifies the source of a phone call or other request to initiate communications, in accordance with one or more aspects of the present disclosure. System 200 of FIG. 2 includes computing system 241, publisher system 191, and user device 211, all capable of communicating over network 205. System 200 of FIG. 2 is similar, in some respects, to system 100A of FIG. 1A and system 100B of FIG. 1B. For example, publisher system 191 of FIG. 2 may correspond to publisher system 191 in FIG. 1A and FIG. 1B. Computing system 241, illustrated in FIG. 2, may be considered an example or alternative implementation of computing system 141 of FIG. 1A and FIG. 1B. Also, user device 211 of FIG. 2 may be considered an example or alternative implementation of user device 111 of FIG. 1A and FIG. 1B.

FIG. 2 illustrates computing system 241 in block diagram form. Although computing system 241 may operate in a manner similar to computing system 141 of FIG. 1A, and user device 211 may operate in a manner similar to user device 111 of FIG. 1A and FIG. 1B, each of computing system 241 and user device 211 are illustrated in FIG. 2 to facilitate a description of certain components, modules, and other aspects of those systems in the context of this disclosure.

For ease of illustration, computing system 241 is depicted in FIG. 2 as a single computing system. However, in other examples, computing system 241 may be implemented through multiple devices or computing systems distributed across a data center, multiple data centers, multiple cloud networks, or otherwise. For example, separate computing systems may implement functionality described herein as being performed by each of various modules of computing system 241, including development module 251, communications module 252, and validation module 253. Alternatively, or in addition, modules illustrated in FIG. 2 as included within computing system 241 may be implemented through distributed virtualized compute instances (e.g., virtual machines, containers) of a data center, cloud computing system, server farm, and/or server cluster.

In FIG. 2, computing system 241 is shown with underlying physical hardware that includes power source 242, one or more processors 244, one or more communication units 245, one or more input devices 246, one or more output devices 247, and one or more storage devices 250. One or more of the devices, modules, storage areas, or other components of computing system 241 may be interconnected to enable inter-component communications (physically, communicatively, and/or operatively). In some examples, such connectivity may be provided by through communication channels, which may include a system bus (e.g., communication channel 249), a network connection, an inter-process communication data structure, or any other method for communicating data. Although computing system 241 of FIG. 2 may be considered an example implementation of computing system 141 of FIG. 1A and FIG. 1B, other implementations are possible.

In the example shown, power source 242 of computing system 241 may provide power to one or more components of computing system 241. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 244 to intelligently consume, allocate, supply, or otherwise manage power. Storage devices 250 may include development module 251, communications module 252, validation module 253, and token storage 259.

One or more processors 244 of computing system 241 may implement functionality and/or execute instructions associated with computing system 241 or associated with one or more modules illustrated herein and/or described herein. One or more processors 244 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, and/or other types of processors or processing circuitry. Processors 244 may execute the instructions of one or more processes executing on computing system 241 and may implement functionality of such processes.

One or more communication units 245 of computing system 241 may communicate with devices external to computing system 241 by transmitting and/or receiving data, and may operate, in some respects, as both an input device and an output device. Communication units 245 may enable computing system 241 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 241 to communicate with any other device illustrated in FIG. 2, such as user device 211 and publisher system 191 over network 205.

One or more input devices 246 may represent any input devices of computing system 241, and one or more output devices 247 may represent any output devices of computing system 241. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 241 may store information for processing during the operation of computing system 241. Storage devices 250 may store program instructions and/or data associated with one or more of the modules described in accordance with one or more aspects of this disclosure. One or more processors 244 and one or more storage devices 250 may provide an operating environment or platform for such modules, which may be implemented as software, but may in some examples include any combination of hardware, firmware, and software. One or more processors 244 may execute instructions and one or more storage devices 250 may store instructions and/or data of one or more modules. The combination of processors 244 and storage devices 250 may retrieve, store, and/or execute the instructions and/or data of one or more applications, modules, or software. Processors 244 and/or storage devices 250 may also be operably coupled to one or more other software and/or hardware components, including, but not limited to, one or more of the components of computing system 241 and/or one or more devices or systems illustrated or described as being connected to computing system 241.

Development module 251 may perform functions relating to development of an application for publication and/or distribution by publisher 190. In some examples, development module 251 may generate code in response to development activity or other input (e.g., from personnel associated with or employed by organization 140). Such code may ultimately execute on one or more user device 211 as application 225. Development module 251 may perform functions similar to development system 151 of FIG. 1A and FIG. 1B.

Communications module 252 may perform functions relating to enabling communications with one or more user device 211 in FIG. 2. In some examples, communications module 252 may be capable of initiating and receiving a traditional voice call over a voice network (such a network may be included within network 205). Alternatively, or in addition, communications module 252 may be capable of initiating and/or receiving a voice call over a data network (e.g., 205) or initiating other types of communications over 205 (e.g., audio or video calls). Communications module 252 may perform functions similar to communication system 152 of FIG. 1A and FIG. 1B.

Validation module 253 may perform functions relating to generating and/or managing storage or retrieval of tokens used to validate and/or verify callers in the manner described herein. Validation module 253 may be capable of generating one or more tokens 103. Validation module 253 may be capable of determining whether data has been derived from a given token 103. Such a capability may enable validation module 253 to determine whether a token 103 received from another device (user device 211) is the same as, corresponds to, or is otherwise based on a token previously sent to that same device. Based on such determinations, validation module 253 may be able to determine whether a caller or source of a call can be authenticated or verified. Validation module 253 may perform functions similar to token services system 153 of FIG. 1A and FIG. 1B.

Token storage 259 of computing system 241 may represent any suitable data structure or storage medium for storing information relating to tokens and other information used to validate calls or other communications. The information stored in token storage 259 may be searchable and/or categorized such that one or more modules within computing system 241 may provide an input requesting information from token storage 259, and in response to the input, receive information stored within token storage 259. Token storage 259 may be primarily maintained by validation module 253.

FIG. 2 also illustrates user device 211 in block diagram form having specific components and data modules. For ease of illustration, only one user device 211 is shown in FIG. 2. However, other user devices 211 could be illustrated (and implemented) in a similar way, although not all of user devices 211 need be implemented in the same way. For example, each of the users that might interact with organization 140 (e.g., customers of a bank represented by organization 140) might possess one or more user devices 211, and each such user device may operate in a manner similar to that described herein. User device 211 is illustrated in FIG. 2 to facilitate a description of how such a device or system may operate in accordance with techniques described herein. User device 211 is also illustrated in FIG. 2 to facilitate a description of certain components, modules, and other aspects of an example user device 211.

The following description of components and data modules included within user device 211 may also apply to any other user device (e.g., other user devices 211) that may be used in accordance with one or more aspects of the present disclosure. As illustrated in FIG. 2, user device 211 includes power source 212, one or more processors 214, one or more communication units 215, one or more input devices 216, one or more output devices 217, and one or more storage devices 220. These components may be implemented in the manner described with respect to similar components (e.g., those of computing system 241) also described herein.

For example, power source 212 may provide power to one or more components of user device 211. One or more processors 214 may implement functionality and/or execute instructions associated with user device 211 or associated with one or more modules of user device 211. One or more communication units 215 of user device 211 may communicate with devices external to user device 211 by transmitting and/or receiving data over a network or otherwise. One or more input devices 216 and output devices 217 may generate, receive, and/or process input and output, respectively.

For each user device 211, input devices 216 and output devices 217 may each function as an input and/or output device or set of input/output devices, and may be implemented using various devices, components, and/or technologies. For example, input devices 216 and output devices 217 may include one or more user interface devices that include presence-sensitive input panel technologies, microphone technologies, voice activation and/or recognition technologies, cameras, sensor technologies (e.g., infrared, image, location, motion, accelerometer, gyrometer, magnetometer), or other input device technology for use in receiving user input. Such user interface devices may include display devices, speaker technologies, haptic feedback technologies, tactile feedback technologies, light emitting technologies, or other output device technologies for use in outputting information to a user. Input devices 216 may include a camera. Input devices 216 may also include, without limitation, a fingerprint reader (e.g., for thumbprint verification), a gyrometer, a keypad, or any other appropriate device for collecting input. Output devices 217A may include a display device, an audio output device, or other types of output devices.

One or more storage devices 220 may store program instructions and/or data associated with one or more of the modules stored within storage devices 220 in accordance with one or more aspects of this disclosure. One or more of the devices, modules, storage areas, or other components of user device 211 may be interconnected (e.g., by communication channel 219). Storage devices 220 of user device 211 may include various modules, such as operating system 221, communications module 222, and data store 229.

Operating system 221 may perform foundational functions capable of being invoked by one or more applications 225 executing on user device 211. In some examples, operating system 221 may include a user interface service library that may perform functions relating to presenting audio, visual, or other information, such as through audio devices, display screens, haptic feedback devices, or otherwise. Operating system 221 may also act as an interface for receiving input from a user, through touch interactions, voice commands, or otherwise. Further, operating system 221 may provide token processing and/or token abstraction services that can be accessed by and/or leveraged by application 225 and/or other applications executing on user device 211.

Communications module 222 may perform functions relating to enabling communications with other computing systems (e.g., computing system 241 or other user devices 211) in FIG. 2. In some examples, communications module 222 may be capable of initiating and receiving a traditional voice call over a voice network (see network 205). Alternatively, or in addition, communications module 222 may be capable of initiating and/or receiving a voice call over a data network (e.g., 205) or initiating other types of communication over 205 (e.g., audio or video calls). Communications module 252 may perform functions similar to communication module 122 of FIG. 1A and FIG. 1B.

Application 225 may be an application configured to perform a specific function on user device 211. Generally, application 225 may be an application developed by an organization (i.e., organization 140) that seeks to use the application to further a business or organizational purpose, and as such, is intended to be used by the customers or users of organization 140. In some examples, application 225 may be a mobile device application that is distributed or published by a trusted third party, such as publisher 190 (e.g., through an “app store” or the like). Accordingly, application 125 may be a banking application, a retail application, or any of a number of other types of applications that may perform productive and/or useful functions when executing on user device 211. To the extent that application 225 is distributed by publisher 190, application 225 may be trusted to be an application that verifiably originates from organization 140 and executes on behalf of organization 140. Application 225 may perform functions similar to those of application 125 of FIG. 1A and FIG. 1B.

Data store 229 may represent any suitable data structure or storage medium for storing information related to operations performed by user device 211. The information stored in data store 229 may be searchable and/or categorized such that one or more modules within user device 211 may provide an input requesting information from data store 229, and in response to the input, receive information stored within data store 229. Data store 229 may be primarily maintained by operating system 221, and may perform functions similar to those described in connection with device registry 129 of FIG. 1A and FIG. 1B.

In FIG. 2, and in accordance with one or more aspects of the present disclosure, computing system 241 may initiate a call to user device 211. For instance, in an example that can be described with reference to FIG. 2, input device 246 of computing system 241 detects input and outputs information about the input to communications module 252. Communications module 252 determines that the input corresponds to a request to initiate a call to user device 211. Communications module 252 causes communication unit 245 to send information packet 101A over network 205. Information packet 101A includes identifier 102A and token 103A. Communication unit 215 of user device 211 detects a signal over network 205 and outputs information about the signal to communications module 222. Communications module 222 of user device 211 determines that the signal corresponds to an incoming call and includes information packet 101A. Communications module 222 parses identifier 102A from information packet 101A. Communications module 222 interacts with operating system 221 to identify, based on identifier 102A, an application associated with the call. Operating system 221 accesses information in device registry 229 and determines that application 225 is associated with the call. Operating system 221 causes communications module 222 to communicate information about information packet 101A to application 225.

User device 211 may verify the call. For instance, still with reference to FIG. 2, application 225 extracts token 103A from information packet 101A. Application 225 outputs a signal over 205 to computing system 241. Communication unit 245 of computing system 241 receives the signal and outputs information about the signal to communications module 252. Communications module 252 determines that the signal includes token 103A from user device 211. Communications module 252 outputs information about token 103A to validation module 253. Validation module 253 determines whether token 103A from user device 211 corresponds to and/or matches the token included in information packet 101A (which computing system 241 previously sent to user device 211 when initiating the call). Validation module 253 causes communication unit 245 to output, over network 205, information about the determination made by validation module 253. Communication unit 215 of user device 211 detects a signal over 205 that application 225 determines includes an indication of whether computing system 241 verified token 103A.

If application 225 determines that computing system 241 verified the token, application 225 interacts with communications module 222 to connect the incoming call from computing system 241, thereby enabling computing system 241 and user device 211 to communicate. Application 225 may interact with operating system 221 to invoke operating system services providing for a notification to be presented at user device 211, notifying a user that a verified call is being received.

If, however, application 225 determines that computing system 241 did not verify the token, application 225 may interact with communications module 222 to refuse the call. In some examples, but not all, application 225 may interact with operating system 221 to invoke operating system services that cause a notification to be presented at user device 211, indicating that a call was received that purported to be from organization 140, but could not be verified as originating from organization 140.

In another example, user device 211 may initiate a call to computing system 241. However, before doing so, user device 211 may prepare to initiate the call. For instance, in another example that can be described with reference to FIG. 2, input device 216 of user device 211 detects input and outputs information about the input to operating system 221. Operating system 221 determines that the input is intended for application 225. Operating system 221 outputs to application 225 information about the input. Application 225 determines that the input corresponds to a request to initiate a call from user device 211 to computing system 241. In preparation for the call, application 225 causes communication unit 215 of user device 211 to output a signal over network 205. Communication unit 245 of computing system 241 detects a signal and outputs information about the signal to validation module 253. Validation module 253 determines that the signal corresponds to a request for a token to use in a verified call being placed by user device 211. Validation module 253 generates token 103B (or retrieves token 103B from token storage 259). Validation module 253 causes communication unit 245 to output a signal over network 205. Communication unit 215 of user device 211 receives a signal over network 205 that application 225 determines includes token 103B.

User device 211 may initiate the call to computing system 241. For instance, still with reference to FIG. 2, application 225 extracts token 103B from the signal received from computing system 241. Application 225 interacts with communications module 222 to cause communications module 222 to include token 103B within information packet 101B to be sent with the initiation of the call to computing system 241. Communications module 222 causes communication unit 215 to initiate the call to computing system 241 over network 205. Communication unit 215 includes information packet 101B when initiating the call.

Computing system 241 may receive the call from user device 211 and verify the caller. For instance, again referring to FIG. 2, communications module 252 of computing system 241 receives an indication of the call initiated by user device 211 and determines that the call includes information packet 101B. Communications module 252 further determines that information packet 101B includes token 103B. Communications module 252 outputs information about token 103B to validation module 253. Validation module 253 determines whether token 103B corresponds to and/or matches the token previously sent by computing system 141 to user device 211 (when user device 211 was preparing to initiate the call to computing system 141). If validation module 253 determines that token 103B can be verified, validation module 253 connects the call initiated by user device 211, thereby enabling user device 211 and computing system 241 to communicate. If validation module 253 cannot verify token 103B received in information packet 101B, validation module 253 may refuse to connect the call initiated by user device 211.

Modules illustrated in FIG. 2 (e.g., development module 251, communications module 252, validation module 253, operating system 221, communications module 222, and application 225) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

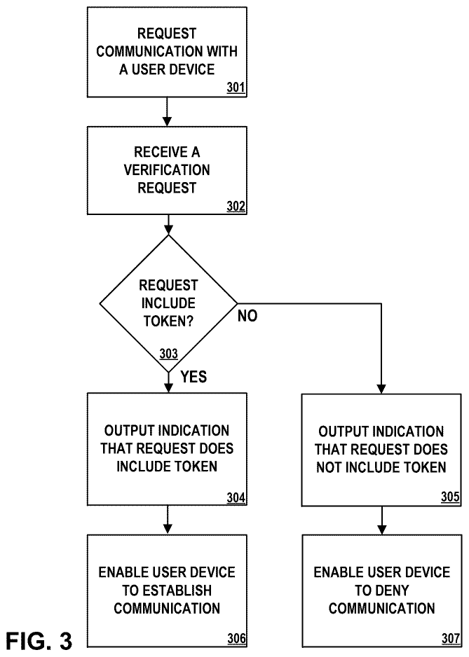

FIG. 3 is a flow diagram illustrating operations performed by an example computing system 141 in accordance with one or more aspects of the present disclosure. FIG. 3 is described below within the context of computing system 141 of FIG. 1A. In other examples, operations described in FIG. 3 may be performed by one or more other components, modules, systems, or devices. Further, in other examples, operations described in connection with FIG. 3 may be merged, performed in a different sequence, omitted, or may encompass additional operations not specifically illustrated or described.

In the process illustrated in FIG. 3, and in accordance with one or more aspects of the present disclosure, computing system 141 may request communication with a user device (301). For example, in FIG. 1A, communication system 152 of computing system 141 outputs a signal over a network to user device 111. Communication module 122 of user device 111 detects a signal and determines that the signal includes token 103A. Communication module 122 outputs information about token 103A to application 125.

Computing system 141 may receive a verification request (302). For example, application 125 determines that user device 111 has received an indication of an incoming call that purports to be from organization 140. Application 125 outputs a verification request over a network to computing system 141, wherein the verification request includes token 103A (or information derived from token 103A that sufficiently establishes that user device 111 has access to token 103A). Communication system 152 of computing system 141 receives the signal from user device 111 and determines that the signal corresponds to a verification request. Communication system 152 may also determine that the signal includes information purporting to be about token 103A.

Computing system 141 may determine whether the request includes the token (303). For example, communication system 152 of computing system 141 outputs information about the signal received from user device 111 to token services system 153. Token services system 153 evaluates the information included within the signal and determines whether the information includes token 103A, or includes enough data to establish that user device 111 has access to token 103A (e.g., the signal includes information derived from token 103A).

Computing system 141 may output to the user device an indication of whether the verification request includes information derived from the validation token. For example, if token services system 153 of computing system 141 determines that the verification request includes token 103A, computing system 141 may output an indication to user device 111 that the request does include the token (304 and YES path from 303). In that case, computing system 141 may enable the user device to establish communication with computing system 141 (306). In another example, if token services system 153 of computing system 141 determines that the verification request does not include token 103A, computing system 141 may output an indication that the request does not include the token (305 and NO path from 303). In this latter case, computing system 141 may enable the user device to decline to establish communication with the caller (307).

In some examples, when computing system 141 sends an indication of whether the verification request includes information derived from the validation token, that indication may be considered sending control signals to user device 111 once the determination has been made about whether the verification request includes information derived from the validation token. In such examples, that indication may be considered instructing user device 111 to either establish communications with computing system 141 or decline to establish communications with computing system 141. Accordingly, in at least some examples, computing system 141 controls the operation of user device 111 through control signals that cause application 125 to establish (or not establish) specific communications.

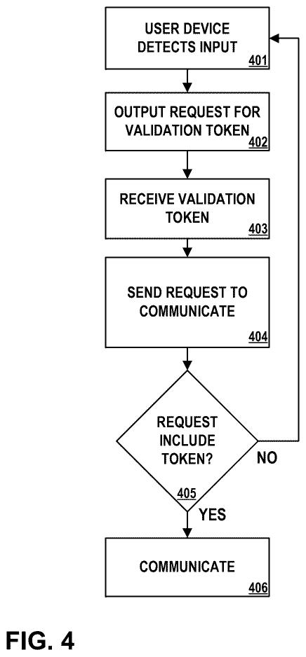

FIG. 4 is another flow diagram illustrating operations performed by an example user device 111 in accordance with one or more aspects of the present disclosure. FIG. 4 is described below within the context of user device 111 of FIG. 1B. In other examples, operations described in FIG. 4 may be performed by one or more other components, modules, systems, or devices. Further, in other examples, operations described in connection with FIG. 4 may be merged, performed in a different sequence, omitted, or may encompass additional operations not specifically illustrated or described.

In the process illustrated in FIG. 4, and in accordance with one or more aspects of the present disclosure, user device 111 may detect input requesting communication (401). For example, user device 111 detects input that it determines corresponds to a request to initiate communications (e.g., a phone call) with computing system 141.

User device 111 may output a request for a token (402). For example, before initiating the call, application 125 outputs a signal over a network to computing system 141 (arrow “3” in FIG. 1B). Token services system 153 of computing system 141 receives the signal and determines that the signal corresponds to a request for a token to be used for caller verification purposes. Token services system 153 generates token 103B (or retrieves token 103B from token storage 159).

User device 111 may receive a validation token (403). For example, token services system 153 causes computing system 141 to output a signal (including token 103B) over the network back to user device 111 (arrow “4”). Application 125 of user device 111 receives the signal and determines that the signal includes token 103B.

User device may send a request to communicate (404). For example, application 125 interacts with communication module 122 to initiate the requested call (arrow “5”). When application 125 interacts with communication module 122, application 125 instructs communication module 122 to include token 103B when initiating the call to computing system 141. Communication module 122 of user device 111 initiates the phone call by communicating a signal over a network to computing system 141 (see arrow “6”). When initiating the call, communication module 122 may include information packet 101B, which may include identifier 102B (e.g., a caller ID associated with user device 111) and token 103B.

User device 111 may enable another computing system to determine that the request includes the validation token (405). For example, communication system 152 of computing system 141 receives a signal that includes information packet 101B. Communication system 152 outputs information about information packet 101B to token services system 153 (see arrow “7”). Token services system 153 extracts token 103B from information packet 101B. Token services system 153 determines whether the extracted token 103B matches or otherwise corresponds to the token previously sent by computing system 141 to user device 111.

User device 111 may enable the computing system to establish communication (406 and YES path from 405). For example, if token 103B that is included within information packet 101B can be verified, computing system 141 concludes that the call being received is from user device 111. In that case, communication system 152 connects the call, enabling computing system 141 and user device 111 to communicate. If computing system 141 cannot verify the token, computing system 141 does not establish communication (NO path from 405).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., computing system 141, computing system 241, publisher system 191, user device 111, operating system 221, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
requesting, by a computing system, communication with a user device, wherein requesting communication includes sending a validation token to the user device over a network;
after sending the validation token to the user device, receiving, by the computing system and from the user device over the network, a verification request;
determining, by the computing system, whether the verification request includes information derived from the validation token;
outputting, by the computing system and to the user device over the network, an indication of whether the verification request includes information derived from the validation token; and
enabling, by the computing system, the user device to determine, based on the indication, whether to establish communication between the user device and the computing system.

2. The method of claim 1, wherein determining whether the verification request includes information derived from the validation token includes:
determining whether the verification request includes the validation token.

3. The method of claim 1, further comprising:
communicating, by the computing system and based on the determination made by the user device, with the user device.

4. The method of claim 1, further comprising:
publishing, by the computing system and with a trusted application publisher, an application; and
enabling, by the computing system, the user device to install the application for execution on the user device.

5. The method of claim 4, wherein receiving the verification request includes:
receiving the verification request from the application executing on the user device.

6. The method of claim 4, wherein requesting communication with the user device further includes a caller identification number to the user device over the network, and wherein receiving the verification request from the application executing on the user device further includes:
enabling the user device to determine, based on the caller identification number, that the requested communication with the user device is associated with the application; and
receiving the verification request from the application executing on the user device.

7. The method of claim 6, wherein the computing system is controlled by an organization, wherein the application has been developed by the organization, and wherein enabling the user device to determine that the requested communication is associated with the application includes:
enabling the user device to determine that the requested communication originated from organization.

8. The method of claim 4, wherein enabling the user device to determine whether to establish communication between the user device and the computing system includes:
enabling the application executing on the user device to determine whether to establish communication between the user device and the computing system.

9. The method of claim 1, wherein the user device is a mobile phone, and wherein requesting communication with the user device includes:
initiating a phone call to the user device.

10. A computing device comprising processing circuitry and a storage device, wherein the processing circuitry has access to the storage device and is configured to:
detect an indication of input requesting communication with a computing system;
output, over a network and to a token services system accessible to the computing system, a request for a token;
receive, in response to the request for the token and from the token services system over the network, a validation token;
send, over the network and to the computing system, a request to communicate with the computing system, wherein the request includes information derived from the validation token;
enable the computing system to determine, by interacting with the token services system, that the request includes information derived from the validation token; and
after enabling the computing system to determine that request includes information derived from the validation token, communicate with the computing system.

11. The computing device of claim 10, wherein to send a request to communicate with the computing system, the processing circuitry is further configured to:
send the validation token with the request.

12. The computing device of claim 10, wherein the processing circuitry is further configured to:
download, from a trusted application publisher, an application; and
install the application for execution on the computing device.

13. The computing device of claim 12,
wherein to output the request for a token, the computing device is further configured to enable the application to output the request for the token;
wherein to receive the validation token, the computing device is further configured to enable the application to receive the validation token; and
wherein to send the request to communicate with the computing system, the computing device is further configured to enable the application to send the request.

14. The computing device of claim 13, wherein to send the request to communicate with the computing system, the computing device is further configured to:
enable the application to send the validation token with the request.

15. The computing device of claim 10,
wherein the computing device is a mobile phone; and
wherein the computing system is another mobile phone.

16. Non-transitory computer-readable media comprising instructions that, when executed, cause processing circuitry of a computing system to:
request communication with a user device, wherein to request communication, the processing circuitry is further configured to send a validation token to the user device over a network;
receive, after sending the validation token to the user device, a verification request over the network from the user device;
determine whether the verification request includes information derived from the validation token;
output, to the user device over the network, an indication of whether the verification request includes information derived from the validation token; and
enable the user device to determine, based on the indication, whether to establish communication between the user device and the computing system.

17. The computer-readable media of claim 16, wherein to determine whether the verification request includes information derived from the validation token, the processing circuitry is further configured to:
determine whether the verification request includes the validation token.

18. The computer-readable media of claim 16, wherein the processing circuitry is further configured to:
communicate, based on the determination made by the user device, with the user device.

19. The computer-readable media of claim 16, wherein the processing circuitry is further configured to:
publish an application with a trusted application publisher; and
enable the user device to install the application for execution on the user device.

20. The computer-readable media of claim 19, wherein to receive the verification request, the processing circuitry is further configured to:
receive the verification request from the application executing on the user device.
